(19) United States
(12) Patent Application Publication
(10) Pub. No.: US 2009/0320299 A1
(43) Pub. Date: Dec. 31, 2009

(54) Scraper Blade

(76) Inventors: Justin Kuhn, Sarasota, FL (US); Brad Allen, Stilwell, KS (US); Ryan Campbell, Overland Park, KS (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/492,792

(22) Filed: Jun. 26, 2009

Related U.S. Application Data
(60) Provisional application No. 61/207,878, filed on Jun. 27, 2008.

(51) Int. Cl. B26D 1/06; B26D 7/26; B26B 7/00

(52) U.S. Cl. 30/169; 30/350; 30/351; 30/355; 30/357; 30/342

(57) ABSTRACT

A scraper blade preferably configured for use with a reciprocating saw. The blade has a first end comprising a mounting structure, and a second end with a cutting edge. The second end is coupled with and spaced apart from the first end. Preferably, the first end is configured to be mounted in a reciprocating saw chuck and the first and second ends are integral. Further, the first and second ends are preferably manufactured from heat treated steel comprising between approximately 0.45 to 1.05% carbon and between approximately 0.3 to 1.0% manganese. Preferably, the steel has a yield tensile strength of between approximately 150,000 to 250,000 pounds per square inch, a modulus of elasticity of between approximately 20,000 to 40,000 kilopounds per square inch, and a hardness on the Rockwell C scale of between approximately 30 to 60.

### CROSS-REFERENCE TO RELATED APPLICATIONS

This application is based on and claims priority to U.S. Provisional Application Ser. No. 61/207,878, filed on Jun. 27, 2008 which is hereby incorporated herein by reference.

### STATEMENT REGARDING FEDERALLY SPONSORED RESEARCH OR DEVELOPMENT

Not applicable.

### BACKGROUND OF THE INVENTION

1. Field of the Invention

This invention relates to a scraper blade, and more particularly to a scraper blade preferably for use in a reciprocating saw.

2. Description of Related Art

Scrapers are used for removing coatings or coverings from a surface. For example, scrapers may remove dried paint or adhesive from a surface, remove grease or oil from a product, remove wallpaper, or remove linoleum flooring. There are many types of commercially available scrapers, including scrapers manufactured from different materials, and scrapers of different sizes, shapes, and configurations.

Two broad categories of scrapers are manual scrapers and powered scrapers. Powered scrapers typically require less force to operate and are quicker than manual scrapers. There are several different types of commercially available powered scrapers. However, each of these scrapers requires the purchase of a relatively expensive specialized tool.

In addition to the commercially available powered scrapers, U.S. Patent Application Publication No. 2005/0199117 discloses an adapter to mount a variety of different tools to a reciprocating saw, including a scraper blade. Fasteners such as set screws, bolts and the like are used to secure the various tools to the adapter.

### BRIEF SUMMARY OF THE INVENTION

The present invention is directed to a scraper blade having a body that extends from a first end, configured to be mounted to a reciprocating saw, to a second end, having a cutting edge for scraping material from a surface. The first end of the blade is preferably configured to be directly mounted in the chuck of a commercially available reciprocating saw. In this manner, the scraper blade is easily secured to the reciprocating saw to conveniently convert the saw into a specialty power scraper tool. Replacement scraper blades can be provided at relatively low cost and a variety of different configurations and compositions of the blades may be supplied for specific types of applications.

For example, the width of the blade's cutting edge may vary depending on the type of material that is being scraped. One type of blade that is preferably used for scraping hard materials such as thinset mortar, ceramic tile, and hard adhesives and epoxies has a cutting edge width of preferably between approximately 1 to 3 inches. For scraping materials such as linoleum, laminate flooring, drywall joint compound, caulk, adhesives, grease, and paint the cutting edge width is preferably between approximately 3 to 5 inches. The cutting edge width is preferably between approximately 5 to 7 inches for scraping softer materials such as rubber-backed carpet, wallpaper, and paint. A cutting edge width of between approximately 7 to 9 inches is preferably used for scraping materials such as rubber backed carpet from a hard substrate such as concrete. The other dimensions of the blade may also vary depending on the material being scraped. Preferable ranges for these dimensions are listed in the detailed description of this application. In one embodiment of the present invention, a scraper blade kit is provided including two or more blades of different width in order to accommodate different applications.

The cutting edge of the scraper blade is preferably a single beveled chisel edge, although it is within the scope of the invention for the cutting edge to comprise a double beveled edge, serrations, or saw-teeth. Additionally, the cutting edge may be convex or wedge-shaped for scraping in more than one direction. Holes, swages, or large openings may be formed in or through the blade to reduce the blade's weight, alter the blade's flexibility, or to prevent scraped material from adhering to the blade during operation. The first and second ends of the blade may also comprise a first material while the cutting edge comprises a material with a hardness that is greater than the hardness of the first material in order to prevent indentations in the cutting edge and increase the life of the blade.

While the physical properties of the material that the blade is made from may differ based on the type of material being scraped, preferably the blade is made from a material with a yield tensile strength that is between approximately 150,000 to 250,000 pounds per square inch (“psi”), more preferably is between approximately 175,000 to 225,000 psi, and most preferably is between approximately 185,000 to 210,000 psi. The material preferably has a tensile modulus of elasticity that is between approximately 20,000 to 40,000 kilopounds per square inch (“ksi”), more preferably is between approximately 25,000 to 35,000 ksi, and most preferably is between approximately 27,500 to 32,500 ksi. Preferably, the material has a hardness on the Rockwell C scale that is between approximately 30 to 60, more preferably is between approximately 40 to 50, and most preferably is between approximately 42 to 48.

While the blade may be made from a variety of materials the blade is preferably made from steel comprising between approximately 0.45 to 1.05% carbon, more preferably between approximately 0.6 to 0.9% carbon, and most preferably between approximately 0.7 to 0.8% carbon. The steel preferably comprises between approximately 0.3 to 1% manganese, more preferably between approximately 0.4 to 0.9% manganese, and most preferably between approximately 0.5 to 0.8% manganese. The steel preferably comprises no more than 0.04% phosphorus and no more than 0.05% sulfur. Preferably, the remainder of the steel comprises iron, however, the blade may also comprise other residual elements such as silicon, aluminum, chromium, vanadium, molybdenum, and nickel. Preferably, the steel is heat treated by martempering or austempering so that the steel has a yield tensile strength, modulus of elasticity, and hardness as specified above. Most preferably, the blade is made from martempered or austempered steel having an American Iron and Steel Institute designation of AISI 1070 or 1074, which corresponds to Uniform Numbering System designations of UNS G10700 and G10740.

The scraper blade is simple to manufacture, inexpensive, and disposable. The blade provides an appropriate scraping leverage to remove material from a surface while flexing to avoid gouging the surface being scraped. The hardness of the blade allows it to maintain a sharp cutting edge without being susceptible to chipping. The tensile strength and modulus of elasticity of the blade allow the blade to flex a desired amount during operation without permanent deformation.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a top plan view of a scraper blade according to an embodiment of the present invention;

FIG. 2 is a partial side elevational view of a cutting edge of the blade of FIG. 1;

FIG. 3 is a top plan view of the blade of FIG. 1 mounted in a reciprocating saw chuck;

FIG. 4 is a partial side elevational view of an alternative embodiment of blade according to the present invention having a double beveled chisel cutting edge;

FIG. 5 is a partial top plan view of an alternative embodiment of blade according to the present invention having a serrated cutting edge;

FIG. 6 is a partial top plan view of an alternative embodiment of blade according to the present invention having a double serrated cutting edge;

FIG. 7 is a partial top plan view of an alternative embodiment of blade according to the present invention having a cutting edge with saw teeth;

FIG. 8 is a partial top plan view of an alternative embodiment of blade according to the present invention having openings through the top and bottom surfaces adjacent the cutting edge;

FIG. 9 is a partial top plan view of an alternative embodiment of blade according to the present invention having swages formed in the top surface adjacent the cutting edge;

FIG. 10 is a partial top plan view of an alternative embodiment of blade according to the present invention having cut-out openings through the top and bottom surfaces adjacent the cutting edge;

FIG. 11 is a top plan view of an alternative embodiment of blade according to the present invention having a handle for manual use;

FIG. 12 is a partial top plan view of an alternative embodiment of blade according to the present invention having a convex cutting edge;

FIG. 13 is a partial top plan view of an alternative embodiment of blade according to the present invention having a wedge-shaped cutting edge;

FIG. 14 is a partial perspective view of an alternative embodiment of blade according to the present invention having a replaceable cutting edge blade;

FIG. 15 is a partial perspective view of an alternative embodiment of blade according to the present invention having a plurality of removable cutting edges;

FIG. 16 is a top plan view of an alternative embodiment of blade according to the present invention having an angled cutting edge;

FIG. 17 is a top plan view of an alternative embodiment of blade according to the present invention having a cutting edge and a serrated side adjacent the cutting edge;

FIG. 18 is a top plan view of an alternative embodiment of blade according to the present invention having chamfers between the cutting edge and adjacent sides;

FIG. 19 is a perspective view of an alternative embodiment of blade according to the present invention having a downwardly extending cutting edge;

FIG. 20 is a top plan view of another alternative embodiment of blade according to the present invention having a generally triangular configuration; and

FIG. 21 is a top plan view of an alternative embodiment of blade according to the present invention having a narrow configuration.

### DETAILED DESCRIPTION OF PREFERRED EMBODIMENT

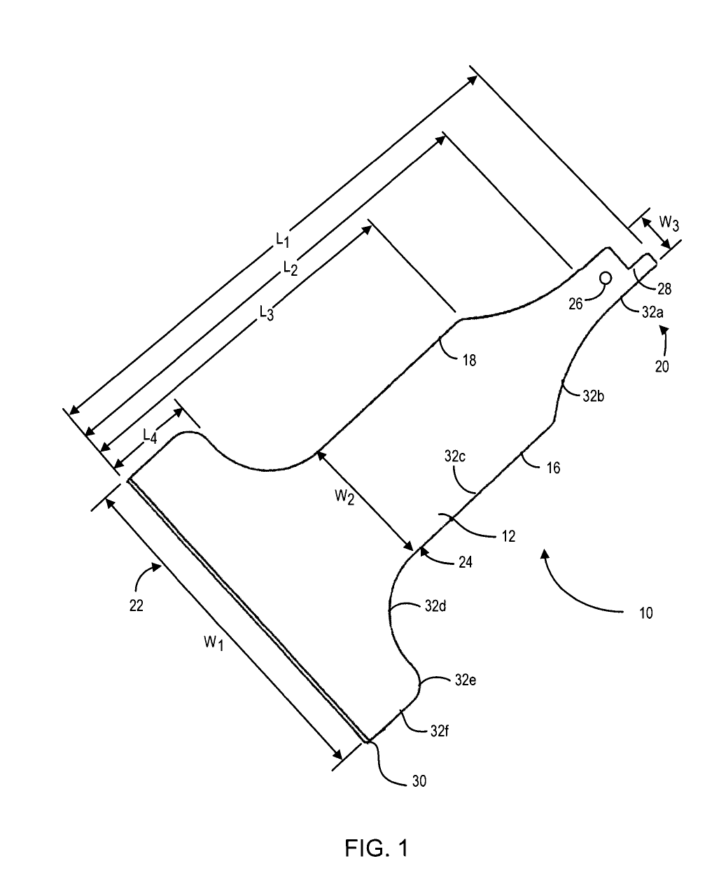

Referring now to FIGS. 1-3, a scraper blade according to one embodiment of the present invention is shown generally as 10. Scraper blade 10 has a unitary body and is formed from a generally planar sheet of material having top and bottom surfaces 12 and 14 and sides 16 and 18. The blade has spaced apart first and second ends 20 and 22, and a waist 24 that is integrally joined with the first and second ends 20 and 22 and positioned between the first and second ends.

Scraper blade 10 is designed for use with a conventional reciprocating saw, such as the one shown as 36 in FIG. 3. Reciprocating saws are commonly used in carpentry and woodworking fields for cutting thin sheets of wood. The reciprocating saw 36, shown in FIG. 3, is an exemplary one, and it should be understood that any type of reciprocating saw may be used with the blade 10. The majority of commercially available reciprocating saws have the following features: a motor contained within an external housing, a linearly or elliptically reciprocating shaft that is joined with the motor via one or more linkages or gears, and a trigger connected to the motor for actuating the motor and the resultant linear or elliptical motion of the shaft. The motor is typically electrically powered via a direct current battery or an electrical cord receiving alternating current from an electrical outlet, however, some motors are pneumatically powered. The end of the reciprocating shaft protrudes through an opening in the housing and has a mounting structure or chuck which is designed to receive a complementary key-like shape of an end of a typical reciprocating saw blade.

A typical mounting structure or chuck includes a guide pin protruding from the side of the reciprocating shaft adjacent the shaft's end that receives a complementary opening on a typical reciprocating saw blade. The shaft typically has a threaded opening that is positioned adjacent to the guide pin. A clamp fits over the saw blade and has an opening which receives a fastener to secure the clamp and blade to the threaded opening on the reciprocating shaft. The clamp may also have a second opening that is aligned with the opening in the saw blade and the guide pin. There are a variety of companies that manufacture reciprocating saws of this type, including companies that sell saws under the following trademarks: DeWalt, Black & Decker, Milwaukee, Delta/Porter-Cable, Makita, Skil, Bosch, Craftsman, and Ryobi. This description of typical reciprocating saws is only illustrative in nature, and it is within the scope of the invention for scraper blade 10 to be used with any type of reciprocating saw.

Referring now to FIG. 1, the first end 20 of scraper blade 10 has the same mounting structure or chuck as the end of a conventional reciprocating saw blade, as described above. That mounting structure includes an opening 26 and a protrusion 28 for mounting the blade in the chuck of reciprocating saw 36. The opening 26 receives a guide pin (not shown) that protrudes from the saw's linearly or elliptically reciprocating shaft (not shown) for positioning the blade within the chuck. A clamp (not shown) is positioned over the first end 20 of the blade 10 such that the blade is positioned between the clamp and the reciprocating shaft of the saw. The clamp has an opening that aligns with a threaded opening on the saw's reciprocating shaft. A threaded fastener is received by the opening in the clamp and engages the threaded opening on the saw's shaft for securing the clamp and scraper blade 10 to the saw. Although preferably the scraper blade 10 is secured to a reciprocating saw as described above, it is within the scope of the invention for the blade to be secured to a reciprocating saw in any manner. For example, the blade may also be mounted to a reciprocating saw having a quick-release chuck. If the blade is being secured to a reciprocating saw that has a different mounting structure than that described above, the first end of the blade can have any structure necessary for mounting to that particular reciprocating saw. Alternatively, the scraper blade may be indirectly mounted to the reciprocating saw by securing the blade to a connector or adapter that is mounted in the reciprocating saw chuck.

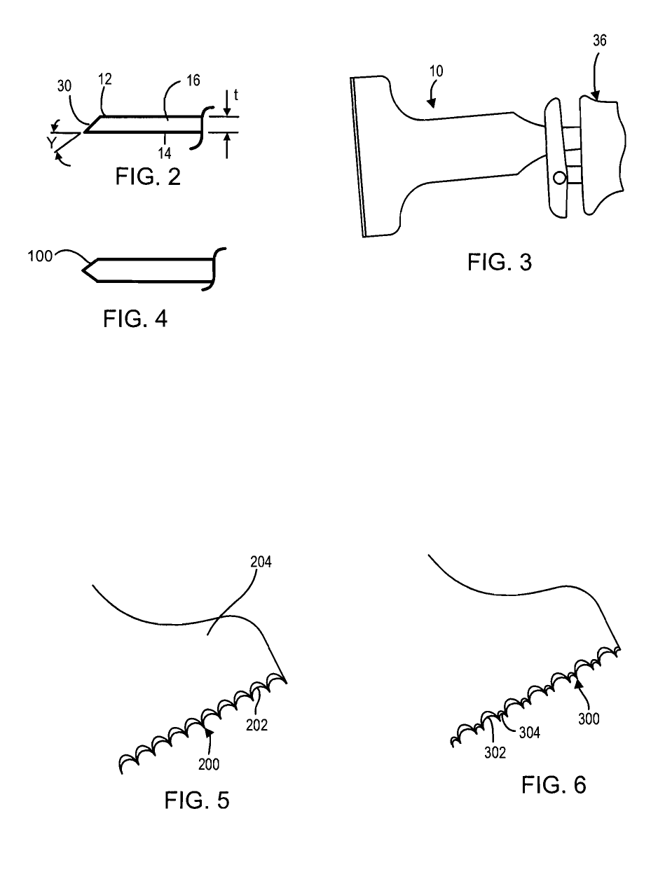

Second end 22 has a cutting edge 30 that is formed as a single beveled chisel for scraping material from a surface. Referring to FIG. 2, cutting edge 30 forms an angle of Y degrees with the bottom surface 14 of the blade. Angle Y is preferably between approximately 25 to 50 degrees, more preferably is between approximately 30 to 40 degrees, and most preferably is approximately 35 degrees. Cutting edge 30 may be used to remove any material from any type of surface. A non-exhaustive list of materials that cutting edge 30 may remove from a surface includes: paint, laminate flooring, wallpaper, glue, rubber-backed carpet, linoleum, chewing gum, mortar, thinset mortar, concrete, adhesive such as ceramic tile adhesive, epoxy, caulk, and drywall joint compound.

Sides 16 and 18 are generally mirror images of each other; therefore, it should be understood that the below description of side 16 also applies to side 18. Starting at first end 20 and moving toward second end 22, side 16 has a linear section 32a extending from protrusion 28. Linear section 32a transitions into a concave arcuate section 32b as the width of the blade increases between the first end 20 and waist 24. Concave arcuate section 32b travels approximately 45 degrees of a circular arc before it is joined with a linear section 32c that is parallel to linear section 32a. Linear section 32c transitions into concave arcuate section 32d, which travels approximately 90 degrees before ending such that a line tangential to the end of the section is perpendicular to linear section 32c. Convex arcuate section 32e extends from arcuate section 32d and travels approximately 90 degrees before transitioning into a linear section 32f that is parallel with linear section 32c. Linear section 32f extends between arcuate section 32e and cutting edge 30, and is perpendicular to the cutting edge. Although preferably the sides of the scraper blade are as described above, it is within the scope of the invention for the sides to have any contour or shape.

Scraper blade 10 preferably has the dimensions listed below, although it is within the scope of the invention for these dimensions to vary. Referring to FIG. 2, blade 10 preferably has a thickness t that is configured so that the blade corresponds with the mounting structure of the reciprocating saw that the blade is used with. Preferably, the thickness t is between approximately 0.03 to 0.13 inches, more preferably between approximately 0.05 to 0.08 inches, and most preferably approximately 0.063 inches. The thickness t of the blade may also be variable such that different sections of the blade have different thicknesses. For example, the first end 20 of the blade may have a first thickness, while the waist 24 and second end 22 have second and third thicknesses that are either greater than or less than the first thickness. Because the thickness of the first end 20 of the blade may be limited by the mounting structure of the reciprocating saw that the blade is used with, it may be desirable to increase the thickness of the waist and second end relative to the first end 20 so that the blade is stiffer and can resist greater forces without yielding. If the blade 10 is used to scrape soft materials such as wallpaper or paint, then it may be desirable to decrease the thickness of the blade so that the blade will flex more. Preferably, if the blade is used to scrape wallpaper or paint, the thickness of the blade is between approximately 0.03 to 0.065 inches.

Referring to FIG. 1, second end 22 and cutting edge 30 preferably have a width W1 between approximately 1 to 9 inches. Preferably, the width W1 of the cutting edge is optimized for scraping a particular material from a particular surface. Blades with shorter widths are preferably used for scraping harder materials because for any force applied to the blade the ratio of total force to cutting edge width is greater for a shorter width blade. Preferably, the width W2 of the waist 24 of the blade is between approximately 0.75 to 2.25 inches, more preferably is between approximately 1 to 1.75 inches, and most preferably is approximately 1.25 inches. The width W3 of first end 20 is preferably configured to correspond with the mounting structure of the reciprocating saw that the blade is used with. Preferably, this width W3 is between approximately 0.25 to 0.75 inches, more preferably is between approximately 0.4 to 0.6 inches, and most preferably is approximately 0.5 inches.

Arcuate section 32b preferably has a radius of between approximately 1 to 3 inches, more preferably between approximately 1.5 to 2.5 inches, and most preferably approximately 2 inches. Arcuate section 32d preferably has a radius of between approximately 0.5 to 1.5 inches, more preferably between approximately 0.75 to 1.75 inches, and most preferably approximately 1 inch. Arcuate section 32e preferably has a radius of between approximately 0.1 to 0.5 inches, more preferably between approximately 0.15 to 0.4 inches, and most preferably between approximately 0.2 to 0.38 inches.

The length of the blade L1, or the distance between first end 20 and second end 22 is preferably between approximately 3.5 to 7.5 inches, more preferably is between approximately 4.5 to 6.5 inches, and most preferably is approximately 5.5 inches. Length L2, which is the distance between second end 32 and the location where linear section 32a and arcuate section 32b meet, is preferably between approximately 2.75 to 6.75 inches, more preferably between approximately 3.75 to 5.75 inches, and most preferably approximately 4.75 inches. The difference between lengths L1 and L2 is preferably the approximate length of the blade that is clamped into the reciprocating saw chuck. Thus, length L2 preferably represents approximately the length of scraper blade 10 that extends from the reciprocating saw chuck, or the distance from the second end 22 of the blade to the location where the first end 20 is secured to the reciprocating saw chuck. When the blade is in use it is subjected to a pressure distribution across its second end 22, which can be resulted into a resultant force. It is believed that the maximum stress on the blade due to this pressure distribution or resultant force occurs approximately a distance L2 from the second end 22 of the blade because this is approximately where the blade is clamped to the reciprocating saw chuck. Thus, it is believed that the distance L2 represents the moment arm for calculating the moment or torque on the blade at the location where the blade is under the most stress.

Preferably, the length L3 of the blade is between approximately 1.75 to 5.75 inches, more preferably is between approximately 2.75 to 4.75 inches, and most preferably is approximately 3.75 inches. The length L4 of the blade is preferably between approximately 0.25 to 2.5 inches, more preferably is between approximately 0.5 to 2 inches, and most preferably is between approximately 0.75 to 1.5 inches. Arcuate section 32b preferably has a length that is the difference between lengths L2 and L3. The length of arcuate section 32d is preferably between approximately 0.5 inches to 1.5 inches, and most preferably is between approximately 0.75 to 1 inches. The length of arcuate section 32e is preferably approximately 0.38 inches.

Protrusion 28 preferably has a length and width corresponding to the mounting structure of the reciprocating saw that the blade is used with. The length of the protrusion is preferably approximately 0.28 inches, and the width is preferably approximately 0.13 inches. Opening 26 is preferably positioned to correspond with the mounting structure of the reciprocating saw that the blade is used with. Preferably, the opening 26 is centered along the width W3 of first end 20. The distance from first end 20 to the center of opening 26 is preferably approximately 0.43 inches. The diameter of opening 26 is preferably approximately 0.15 inches.

Preferably, the ratio of L2 to W3 is between approximately 4 to 27, more preferably is between approximately 6 to 14, and most preferably is approximately 10. Preferably, the ratio of L2 to t is between approximately 21 to 225, more preferably is between approximately 47 to 1115, and most preferably is approximately 75. Preferably, the ratio of W3 to t is between approximately 2 to 25, more preferably is between approximately 5 to 12, and most preferably is approximately 8.

Preferably, the width W1 of the scraper blade may vary depending on what material is being scraped. According to one embodiment of scraper blade 10, cutting edge 30 has a width that is between approximately 1 to 3 inches, more preferably is between approximately 1.5 to 2.5 inches, and most preferably is approximately 2 inches. This embodiment of blade is preferably used for scraping hard materials such as mortar, thinset mortar, concrete, ceramic tile adhesives, epoxy, and other hard adhesives. Another embodiment of scraper blade 10 has a cutting edge 30 with a width that is between approximately 3 to 5 inches, more preferably is between approximately 3.5 to 4.5 inches, and most preferably is approximately 4 inches. This embodiment of blade is preferably used as a utility blade for scraping materials such as linoleum, laminate flooring, drywall joint compound, caulk, adhesives, grease, and paint. Another embodiment of scraper blade 10 has a cutting edge 30 with a width that is between approximately 5 to 7 inches, more preferably is between approximately 5.5 to 6.5 inches, and most preferably is approximately 6 inches. This embodiment of blade is preferably used for scraping materials such as rubber-backed carpet, wallpaper, and paint. Another embodiment of scraper blade 10 has a cutting edge 30 with a width that is between approximately 7 to 9 inches, more preferably is between approximately 7.5 to 8.5 inches, and most preferably is approximately 8 inches. This embodiment of blade is preferably used for scraping materials such as rubber backed carpet from a hard substrate such as concrete. It is also within the scope of the invention to provide a set that has more than one blade with at least two blades in the set preferably having different cutting edge widths.

While there are many different embodiments of scraper blades that may be made according to the present invention, one embodiment of blade 10 has a cutting edge 30 with a width W1 that is approximately 2 inches. The width W2 of waist 24 is approximately 1.25 inches, and the width W3 of the first end 20 of the blade is approximately 0.5 inches. The length L1 of the blade is approximately 5.5 inches, the length L2 is approximately 4.8 inches, the length L3 is approximately 3.6 inches, and the length L4 is approximately 1.1 inches. The thickness of the blade is approximately 0.06 inches. The radius of arcuate section 32b is approximately 2 inches, the radius of arcuate section 32d is approximately 1 inch, and the radius of arcuate section 32e is approximately 0.20 inches. The length of arcuate section 32b is approximately 1.1 inches, the length of arcuate section 32d is approximately 0.75 inches, and the length of arcuate section 32e is approximately 0.1 inches.

Another embodiment of blade 10 according to the present invention has a width W1 that is approximately 4 inches. The width W2 of waist 24 is approximately 1.25 inches, and the width W3 of the first end 20 of the blade is approximately 0.5 inches. The length L1 of the blade is approximately 5.5 inches, the length L2 is approximately 4.8 inches, the length L3 is approximately 3.6 inches, and the length L4 is approximately 0.9 inches. The thickness of the blade is approximately 0.06 inches. The radius of arcuate section 32b is approximately 2 inches, the radius of arcuate section 32d is approximately 1 inch, and the radius of arcuate section 32e is approximately 0.38 inches. The length of arcuate section 32b is approximately 1.1 inches, the length of arcuate section 32d is approximately 1 inch, and the length of arcuate section 32e is approximately 0.38 inches.

Another embodiment of blade 10 according to the present invention has a width W1 that is approximately 6 inches. The width W2 of waist 24 is approximately 1.25 inches, and the width W3 of the first end 20 of the blade is approximately 0.5 inches. The length L1 of the blade is approximately 5.5 inches, the length L2 is approximately 4.8 inches, the length L3 is approximately 3.6 inches, and the length L4 is approximately 1.4 inches. The thickness of the blade is approximately 0.06 inches. The radius of arcuate section 32b is approximately 2 inches, the radius of arcuate section 32d is approximately 1 inch, and the radius of arcuate section 32e is approximately 0.38 inches. The length of arcuate section 32b is approximately 1.1 inches, the length of arcuate section 32d is approximately 1 inch, and the length of arcuate section 32e is approximately 0.38 inches.

It is also anticipated that a kit comprising two or more scraper blades of different size or shape may be provided for use in different types of applications. For example, a kit comprising a scraper blade configured to be particularly well adapted to scrape hard materials, a blade configured to be particularly well adapted to scrape medium-hard materials and a blade configured to be particularly well adapted to scrape soft materials may be provided. This kit may comprise a scraper blade having a width W1 ranging from about 1 to 4 inches, a scraper blade having a width W1 ranging from about 4-6 inches and a scraper blade having a width ranging from about 6-8 inches.

Scraper blade 10 can be manufactured from any material such as metal, plastic, wood, fiberglass, or any other composite material. In one preferred embodiment the blade is a metal such as steel or aluminum. For a metal blade it is within the scope of the invention for any type of heat treatment to be applied to the blade so that the blade has desirable physical properties such as tensile strength, elasticity, and hardness. It is also within the scope of the invention to form waist 12 from a flexible material such that the first and second ends 20 and 22 may be positioned at different angles with respect to the material being scraped. This may assist a user of the blade in imparting the appropriate amount of force at a desirable angle for removing the material being scraped.

According to one embodiment of the present invention, blade 10 is steel. The chemical composition and heat treatment of the steel may be modified as desired to ensure that the blade performs appropriately for the types of materials being scraped. For example, the tensile strength and elasticity of the blade may be altered to ensure that the blade is rigid enough to scrape the desired material, but flexible enough so that the blade does not bend or break. Likewise, the hardness of the blade may be altered so that the blade is hard enough to scrape the desired material, but not so brittle that the blade chips or breaks. By altering the chemical composition and heat treatment of the steel it is possible to manufacture a blade that flexes enough to exert a sufficient amount of force without bending or breaking the blade, and that has a cutting edge which maintains sharpness while minimizing pitting, chipping, and cracking.

While the preferable physical properties of the material that blade 10 is constructed from are listed herein, it is within the scope of the invention for the material that the blade is made from to have different physical properties. Preferably, blade 10 is made from a material with a yield tensile strength that is between approximately 150,000 to 250,000 pounds per square inch (“psi”), more preferably is between approximately 175,000 to 225,000 psi, and most preferably is between approximately 185,000 to 210,000 psi. The material preferably has an ultimate tensile strength of between approximately 180,000 to 265,000 psi, more preferably is between approximately 200,000 to 245,000 psi, and most preferably is between approximately 215,000 to 230,000 psi. The material preferably has a tensile modulus of elasticity that is between approximately 20,000 to 40,000 kilopounds per square inch (“ksi”), more preferably is between approximately 25,000 to 35,000 ksi, and most preferably is between approximately 27,500 to 32,500 ksi.

Preferably, the material that the blade 10 is made from has a hardness on the Rockwell C scale that is between approximately 30 to 60, more preferably is between approximately 40 to 50, and most preferably is between approximately 42 to 48. Preferably, the material has a microhardness on the Knoop hardness scale using a 500 gram load of between approximately 300 to 700, more preferably is between approximately 400 to 550, and most preferably is between approximately 450 to 500.

While it is believed that the following equations and calculations can approximate the behavior of scraper blade 10 as described herein when it is used in a reciprocating saw and subjected to a pressure distribution along its cutting edge 30, it should be understood that the present invention is not limited to the calculations set forth herein. It is believed that when in use scraper blade 10 approximates the behavior of a cantilevered beam with the first end 20 being fixed in the reciprocating saw chuck and the opposite second end 22 having a pressure distribution applied to it which can be resulted into a resultant force F. One equation that is commonly used to approximate the bending stress of a cantilevered beam subjected to a force at its free end is:

$$σ = \frac{M c}{I} \qquad [ 1 ]$$

where σ=the maximum normal stress in the beam, M=the resultant internal moment in the beam, c=the distance from the neutral axis of the beam to a point farthest away from the neutral axis, and I=the moment of inertia of the cross-sectional area about the neutral axis. For the scraper blade 10 described herein, the value c=one half of the thickness of the blade, the value M=the resultant force (F) applied to the second end 22 of the blade multiplied by the distance from the resultant force to the desired location on the blade where the stress is being calculated (L), and the value I is calculated from the following equation, which represents the moment of inertia for a beam having a rectangular cross-sectional area:

$$I = \frac{{wt}^{3}}{12} \qquad [ 2 ]$$

where w=the width of the blade and t=the thickness of the blade. Putting these equations together yields the following:

$$σ = \frac{6 FL}{{wt}^{2}} . \qquad [ 3 ]$$

For a preferred embodiment of blade 10 that has a constant thickness, it can be seen from the above equation that the location of the blade that is subjected to the most bending stress is where the ratio L/w is the greatest. If blade 10 is clamped into a reciprocating saw chuck such that the distance L2 represents the distance from the second end 22 of the blade to where the blade is clamped, then the maximum stress in the blade occurs a distance L2 from the end of the blade, which is where the blade's width W3 is the least. Thus, for blade 10, the maximum bending stress on the blade can be approximated by the following formula:

$${σ}_{max} = \frac{6 {FL}_{2}}{{W}_{3} {t}^{2}} . \qquad [ 4 ]$$

To calculate the maximum force that can be applied to the second end of the blade without having the blade yield and plastically deform due to the bending stress, equation number [4] above can be rewritten as:

$$F = \frac{{σ}_{Y} {W}_{3} {t}^{2}}{6 {L}_{2}} \qquad [ 5 ]$$

where σ_{Y}=the yield tensile strength of the material that the beam is made from.

Preferably, one embodiment of blade 10 according to the present invention can withstand a resultant force applied to second end 22 of between approximately 5 to 50 pounds, more preferably between approximately 7 to 30 pounds, and most preferably between approximately 10 to 20 pounds without yielding. Using the preferable ranges of force that this embodiment of blade can withstand without yielding and the above equation [5], the value of (σ_{Y}·W₃·t²)/L₂, which will hereinafter be referred to as C, is preferably between approximately 30 to 300 pounds, more preferably between approximately 42 to 180 pounds, and most preferably between approximately 60 to 120 pounds. While the above equations do not take into account impact, vibration, and repeated loading, which each will reduce the ability of the blade to withstand force without yielding, it is believed that this embodiment of blade performs satisfactorily for scraping the materials specified above.

The approximate deflection of the second end 22 of blade 10 when a force F is applied to the second end of the blade can be calculated using a bending beam formula for a cantilevered beam, which as discussed above closely approximates the configuration of blade 10 when it is secured to a reciprocating saw chuck. The deflection of the second end 22 of the blade can be approximated based on the following formula:

$${υ}_{max} = \frac{4 {FL}_{2}^{3}}{{Ew}_{3} {t}^{3}} \qquad [ 6 ]$$

where νₘₐₓ=the deflection at the second end 22, F=the force applied to the second end of the blade, L2=the distance between the second end 22 of the blade and where the blade is secured to the reciprocating saw chuck, E=the modulus of elasticity of the blade, W3=the width of the blade where it bends, and t=the thickness of the blade where it bends. When the end of the preferred embodiment of scraper blade 10 is subjected to a force of approximately 15 pounds, which is within the most preferable range of forces specified above that the blade can accept without yielding, preferably the second end 22 of the blade deflects between approximately 1 to 3 inches, more preferably between approximately 1.25 to 2.75 inches, and most preferably between approximately 1.5 to 2.5 inches. Using the preferable deflections at the second end 22 of this embodiment of blade when subjected to a force of 15 pounds and the above equation [6], the value of L₂³/(E*w₃*t³), which will hereinafter be referred to as D, is preferably between approximately 0.017 to 0.05 inches, more preferably between approximately 0.02 to 0.045 inches, and most preferably between approximately 0.025 to 0.04 inches.

While preferably blade 10 is constructed of a material having the properties identified above for yield and ultimate tensile strength, modulus of elasticity, and hardness (Rockwell C scale and Knoop 500 gram), it is within the scope of the invention for the material to not correspond with one or more of the ranges set forth above for those values. Preferably, the blade is constructed from steel comprising at least iron, carbon, and manganese. The steel preferably comprises between approximately 0.45 to 1.05% carbon, more preferably between approximately 0.6 to 0.9% carbon, and most preferably between approximately 0.7 to 0.8% carbon. The steel preferably comprises between approximately 0.3 to 1% manganese, more preferably between approximately 0.4 to 0.9% manganese, and most preferably between approximately 0.5 to 0.8% manganese. The steel preferably comprises no more than 0.04% phosphorus and no more than 0.05% sulfur. Preferably, the remainder of the steel comprises iron, however, the blade may also comprise other residual elements such as silicon, aluminum, chromium, vanadium, molybdenum, and nickel. Certain types of steel that fall within the elemental ranges given above include steel having the following designations from the American Iron and Steel Institute (“AISI”) 1050, 1055, 1060, 1065, 1070, 1074, 1080, 1090, and 1095. These types of steel correspond to the following types of steel as identified using the Unified Numbering System (“UNS”): G10500, G10550, G10600, G10650, G10700, G10740, G10800, G10900, and G10950. Most preferably, the type of steel used to construct blade 10 from is AISI 1070 (UNS G10700) or AISI 1074 (UNS G10740) steel.

Preferably, if blade 10 comprises a metal such as aluminum or steel, including any of the steel compositions described above, the blade is heat treated so that it falls within the ranges specified above for yield and ultimate tensile strength, modulus of elasticity, and hardness. The blade is heat treated to have a desired tensile strength, modulus of elasticity, and hardness so that the blade is durable and the cutting edge does not chip or crack. Any type of heat treatment process may be used to temper the blade including, but not limited to, annealing, precipitation hardening, martempering, and austempering. It is also within the scope of the invention for the surface of the blade to be hardened by a surface hardening process such as carburizing, nitriding, or flame hardening. Surface hardening may be used in conjunction with or separately from a heat treatment process that is performed on the entire blade. Additionally, different portions of the blade may be heat treated using different processes so that those portions have different properties with respect to each other. For example, the entire blade may be annealed, and then cutting edge 30 may undergo surface hardening so that it is harder than the rest of the blade.

While any heat treatment process may be used for blade 10, preferably the blade is martempered or austempered. Martempering typically includes the steps of: (1) austenitizing steel, (2) quenching the steel in hot oil or molten salt to a temperature just above the temperature at which martensite forms, (3) maintaining this temperature for a period of time until the temperature throughout the steel is substantially uniform, and (4) cooling the steel at a moderate rate. The process may also include a fifth step of tempering the steel by heating it to a temperature between the austenite and martensite start temperatures, and then quenching the heated steel. Variations in the above-described martempering process are within the scope of the invention. Austempering typically includes the steps of: (1) austenitizing steel, (2) quenching the steel in hot oil or molten salt to a temperature that permits the formation of bainite, (3) maintaining that temperature until the temperature throughout the steel is substantially uniform, and (4) cooling the steel at a moderate rate to form bainite. Like with martempering, an additional step of tempering the steel may be used, however, it is typically not necessary. Preferably, the austempering or martempering process is carried out in a manner so that the blade has a yield and ultimate tensile strength, modulus of elasticity, and hardness with values as specified above.

Blade 10 may also comprise more than one material so that different portions of the blade have different characteristics. For example, one embodiment of blade according to the present invention has a cutting edge 30 that is formed from or coated with a different material then the remainder of the blade. Preferably, the cutting edge is formed from or coated with a material that has a hardness on the Rockwell C scale that is greater then the hardness of the material comprising the remainder of the blade. This makes the cutting edge less susceptible to indentation, which increases the life of the blade. A non-exhaustive list of materials that the cutting edge may be formed from or coated with include a carbide or nitride such as cemented carbide, titanium carbide, tungsten carbide, boron carbide, silicon carbide, vanadium carbide, titanium carbide nitride, titanium nitride, titanium aluminum nitride, or cubic boron nitride, polycrystalline diamond, natural diamond, or any combination of these materials. The remainder of the blade may be formed from any of the materials described above, such as steel. The different materials may be bonded or joined by any manner including, but not limited to, adhesive, fasteners, brazing, chemical vapor deposition, physical vapor deposition, and sintering. Constructing the blade with a cutting edge formed from a harder material then the rest of the blade increases the useful life of the cutting edge while still allowing the remainder of the blade to retain its desirable properties, such as low cost, elasticity, and strength. When scraping a hard material such as thinset mortar, preferably the blade has a cutting edge that is harder then the remainder of the blade as described herein.

The cutting edge may also comprise more then one material. For example, the cutting edge may comprise a base formed from any of the materials identified above that is coated with another of the materials identified above. In one embodiment, the cutting edge comprises a base formed from cemented carbide that is coated with a material such as titanium carbide, titanium nitride, titanium carbide nitride, or titanium aluminum nitride. The cutting edge 30 may also be sharpened or re-sharpened by conventional means over the life of the blade.

According to another embodiment of blade 10 according to the present invention, the blade is made from a polymeric material such as acetal or a thermoplastic polyester elastomer such as Hytrel®, which is a trade name of E.I. du Pont de Nemours and Company. According to one embodiment of blade 10 according to the present invention, the blade is made from one of the following types of Hytrel®: Hytrel® HTR6108, Hytrel® 6356, Hytrel® 7246, or Hytrel® 8283. This embodiment of blade preferably has a hardness on the Shore D scale of between approximately 55 to 85. The blade preferably has a flexural modulus at around 73 degrees Fahrenheit of between approximately 25 to 170 kilopounds per square inch. This embodiment of blade is preferably used for scraping material such as paint or wallpaper from softer surfaces susceptible to gouging such as drywall.

FIGS. 4-21 show a few of the many alternative embodiments that are within the scope of the invention. Except for the differences described below, each of these alternative blade embodiments is preferably the same as blade 10 described above and shown in FIGS. 1 and 2. Further, the alternative blade embodiments of FIGS. 4-21 may be manufactured from any of the materials described above, and undergo any of the heat treatment and surface hardening processes described above.

Referring to FIG. 4, the cutting edge 100 of an alternative embodiment of blade is shown. Cutting edge 100 is a double beveled chisel, which may be more desirable for scraping certain materials than the single beveled chisel shown in FIGS. 1 and 2.

Referring now to FIGS. 5 and 6, alternative embodiments of blades are shown with serrated cutting edges. FIG. 5 shows a cutting edge 200 with serrations, one of which is shown as 202. The serrations extend from the cutting edge 200 to the top surface 204 of the blade. FIG. 6 shows a cutting edge 300 with alternating serrations 302 and 304 of different sizes. Serrations 302 have a width that is approximately twice the size of serrations 304.

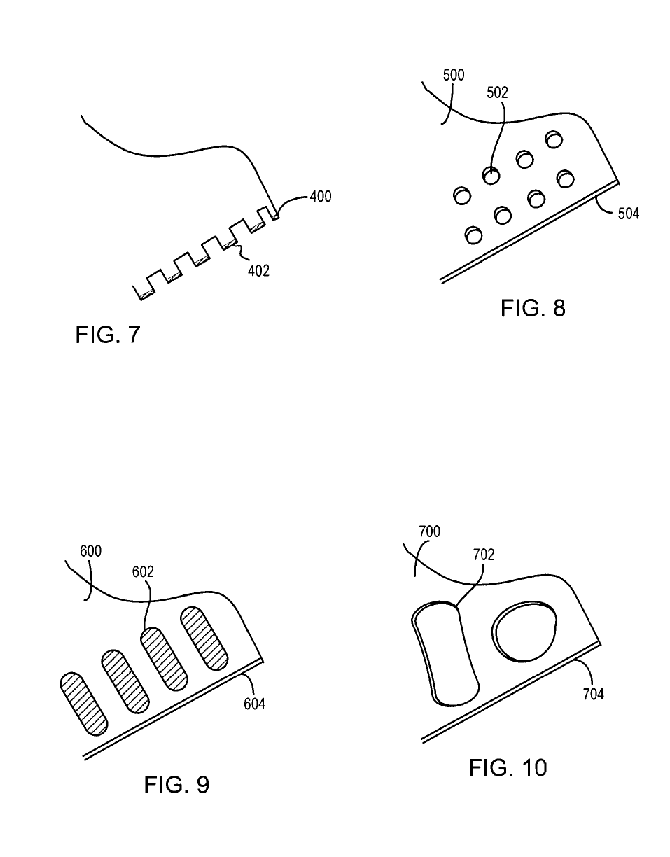

FIG. 7 shows another alternative embodiment of blade with a cutting edge 400 that is formed into saw teeth, one of which is shown as 402. The saw teeth may also be referred to as chisel points or saw blade points.

Referring now to FIGS. 8, 9, and 10, alternative embodiments of blades are shown with indentations or openings formed in the top surface of the blade adjacent the cutting edge. FIG. 8 shows a blade having a top surface 500 with openings or through-holes, one of which is shown as 502, that are adjacent the cutting edge 504. FIG. 9 shows a blade having a top surface 600 with indentations or swages, one of which is shown as 602, formed thereon adjacent the cutting edge 604. FIG. 10 shows a blade having a top surface 700 with cut-out areas or skeletal areas, one of which is shown as 702, that are adjacent the cutting edge 704. Scraped materials, and particularly wet scraped materials, may adhere to a blade with a flat and uninterrupted top surface. The openings, swages, and cut-out areas shown in FIGS. 8-10 reduce the total surface area of the top surface of the respective blade, which reduces the adherence of scraped materials to the top surface of the blade. The openings and cut-out areas shown in FIGS. 8 and 10 also reduce the adherence of scraped materials to the bottom surface of the blade. The openings, swages, and cut-out areas also reduce the weight of the blade and may be used to reduce the blade's stiffness.

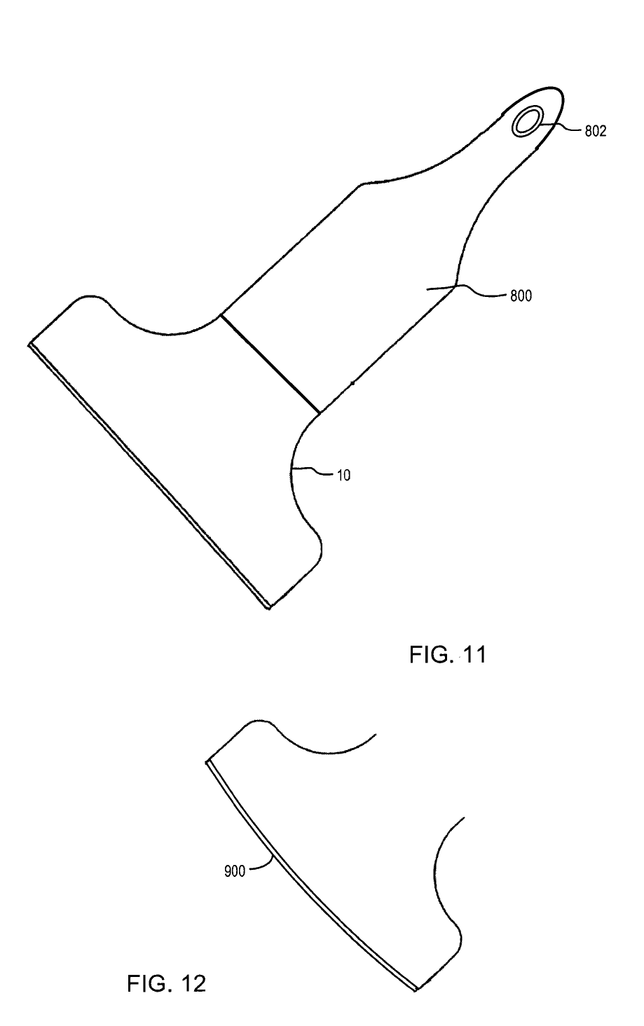

Referring now to FIG. 11, blade 10 is shown with a handle 800 mounted to the first end of the blade for manual use. The handle slides on to the blade and has a cavity (not shown) that is shaped to receive the first end and a portion of the waist of the blade. Preferably, the handle is formed of a resilient material such as rubber or plastic that allows a user to easily grasp the handle, although it is within the scope of the invention to form the handle from any material. The material and cavity are preferably configured so that the handle securely mounts to the blade and does not separate from the blade when in use. While scraping with a reciprocating saw and scraper blade 10 is quicker than manual scraping and requires less force than manual scraping, it is within the scope of the invention for the scraper blade to be used with handle 800 for manual scraping. Handle 800 may also be positioned over the first end of the blade to protect the first end of the blade when the blade is transported or otherwise not in use. Protecting the blade in this manner ensures that the first end can be accurately mounted in a reciprocating saw chuck.

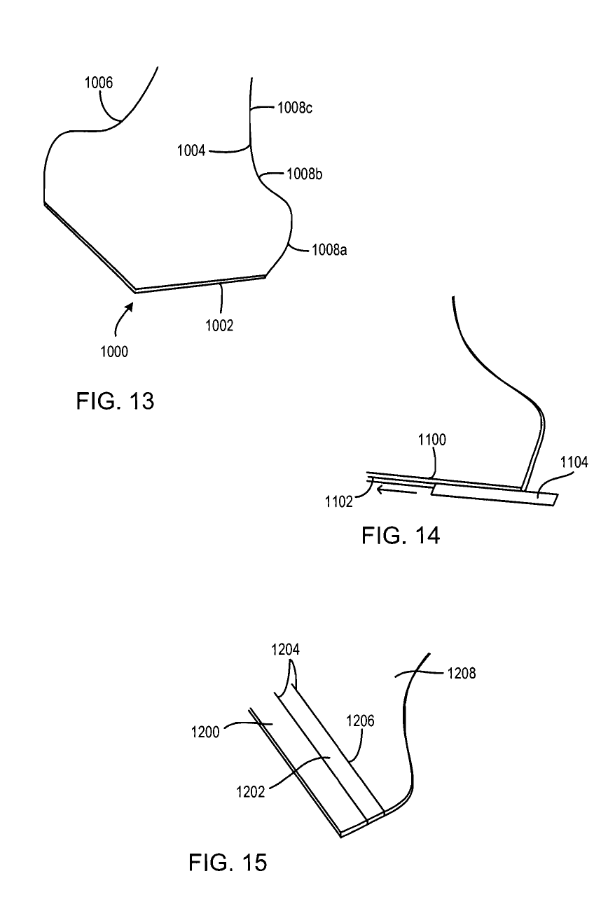

Referring now to FIGS. 12 and 13, alternative embodiments of blades are shown with non-linear cutting edges. FIG. 12 shows a blade having a convex cutting edge 900. FIG. 13 shows a blade 1000 with a wedge-shaped cutting edge 1002. The sides 1004 and 1006 of blade 1000 also have a slightly different shape than the sides of blade 10, which are shown in FIG. 1. Because side 1006 is a mirror image of side 1004, only the construction of side 1004 will be described herein. An arcuate convex portion 1008a of side 1004 is joined to cutting edge 1002 and extends rearward of the cutting edge at an obtuse angle to the cutting edge. Portion 1008a transitions into an arcuate concave portion 1008b, which transitions into a generally linear portion 1008c that defines the waist of the blade. The remainder of the side (not shown) is preferably the same as blade 10, which is shown in FIG. 1.

The convex and wedge-shaped cutting edges shown in FIGS. 12 and 13 allow scraping in multiple directions without changing the orientation of the scraper blade in relation to the surface being scraped. Further, a non-linear cutting edge such as those shown in FIGS. 12 and 13 may alleviate gouging or roughness that may occur on certain surfaces when using a scraper blade with a linear cutting edge. Although only two embodiments of blades with non-linear cutting edges are shown and described herein, it is within the scope of the invention for the cutting edge to have any shape.

FIG. 14 shows an alternative embodiment of blade with a cutting edge 1100 that has a slot 1102. A replaceable blade 1104 is received and retained by slot 1102. When in use, blade 1104 is securely retained within slot 1102 in such a manner that the blade will not inadvertently slide out of the slot. Preferably, blade 1104 is secured within slot 1102 by frictional engagement with the slot or an interference fit, although any structure, mechanism, or bonding technique may be used for securing the blade within the slot, including a clamping mechanism. The slot may be configured to accept replacement cutting blades that are commercially available from a variety of manufacturers, and that are commonly used in manual scrapers for light duty scraping, such as the removal of wallpaper. These commercially available replacement blades are similar in construction to conventional razor blades but generally have a longer cutting edge. It is also within the scope of the invention for the replaceable blade to be formed from or coated with a different material then the remainder of the blade. For example, the replaceable blade may be formed from or coated with a material that is harder then the remainder of the blade, including a carbide or nitride such as cemented carbide, titanium carbide, tungsten carbide, boron carbide, silicon carbide, vanadium carbide, titanium carbide nitride, titanium nitride, titanium aluminum nitride, or cubic boron nitride, polycrystalline diamond, natural diamond, or any combination of these materials.

Referring now to FIG. 15, another alternative embodiment of blade has removable cutting edges 1200 and 1202 serially aligned along the width of the blade. A groove 1204 is formed between cutting edges 1200 and 1202 for removing cutting edge 1200 and exposing cutting edge 1202. A permanent cutting edge 1206 is formed integrally with the waist 1208 of the blade. Another groove 1204 is formed between cutting edges 1202 and 1206 for exposing cutting edge 1206. Preferably, to remove either of cutting edges 1200 or 1202, the cutting edge to be removed is grasped and moved upward and downward to separate it from the rest of the blade at the respective groove 1204. Although only two removable cutting edges are shown, it is within the scope of the invention to have any number of serially aligned removable cutting edges that are separated by grooves.

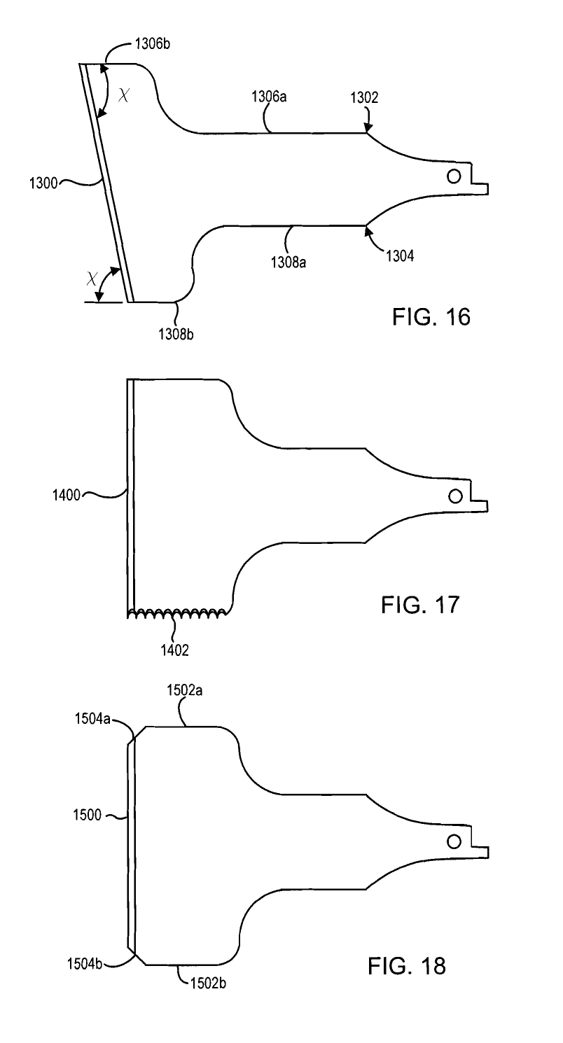

FIG. 16 shows an alternative embodiment of blade that has a linear cutting edge 1300 which forms a non-perpendicular angle X with the linear portions 1306a-b and 1308a-b of the sides 1302 and 1304 of the blade. Preferably, angle X is between approximately 45 to 85 degrees, and most preferably between approximately 65 to 75 degrees. The angled cutting edge makes it easier to scrape certain materials with the blade, such as linoleum, laminate flooring, and rubber backed carpet.

Referring now to FIG. 17, an alternative embodiment of blade is shown with a cutting edge 1400 and a serrated side edge 1402 joined with the cutting edge and extending rearward from the cutting edge toward the opposite end of the blade. The cutting edge 1400 is preferably a single or double beveled chisel edge as shown in FIGS. 2 and 4, and may be used to scrape materials from any surface as described above with respect to blade 10. Serrated side edge 1402 may be used in the same manner as a conventional reciprocating saw blade to cut through any material. Thus, the blade shown in FIG. 17 may be used as either a scraper or a saw.

FIG. 18 shows an alternative embodiment of blade that has a cutting edge 1500, side portions 1502a and 1502b that are adjacent the cutting edge, and chamfers 1504a and 1504b formed between the cutting edge 1500 and the respective sides 1502a and 1502b joined to the cutting edge. The chamfers reduce the possibility that the blade will catch on materials being scraped from a surface. If the blade does catch, then the chamfers reduce the severity of any “kickback” caused by the catching. Thus, the chamfers allow for faster and safer operation of the blade.

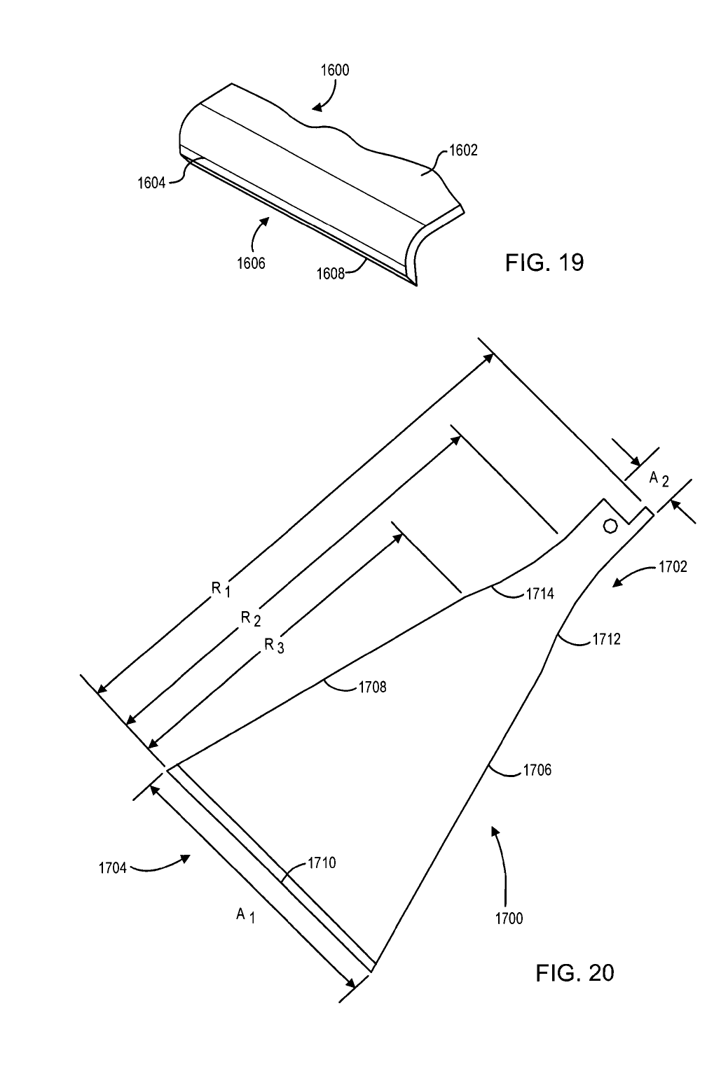

FIG. 19 shows an alternative embodiment of blade 1600 that is similar to the embodiment of blade shown in FIG. 1 except that blade 1600 has two integral sections 1602 and 1604 positioned at an angle with respect to each other. Preferably, there is an angle of between approximately 65 to 115 degrees between sections 1602 and 1604, and most preferably the sections 1602 and 1604 are perpendicular to each other. At the second end 1606 of the blade, section 1604 extends downwardly from section 1602. Section 1604 has a cutting edge 1608 for scraping material from a surface. This embodiment of blade is preferably used for scraping paint, however, it may be used to scrape any material. The blade may be made from any of the materials described above with respect to blade 10, shown in FIG. 1, and it may have any of the dimensions described above with respect to blade 10.

FIG. 20 shows an alternative embodiment of blade 1700 having a unitary body with first and second ends 1702 and 1704 respectively. First end 1702 has the same configuration as the first end of blade 10, shown in FIG. 1, for securing blade 1700 to a reciprocating saw. Blade 1700 has sides 1706 and 1708 and a cutting edge 1710, which in combination are generally in the shape of a triangle. The blade has concave arcuate sections 1712 and 1714 which each have one end joined respectively with sides 1706 and 1708 and another end joined with first end 1702. The blade has an overall length R1, a length R2 representing the length of side 1708 and arcuate section 1714, and a length R3 representing the length of side 1708. The width of the blade's cutting edge 1710 is A1 and the width of first end 1702 is A2. The blade has a decreasing width from its cutting edge 1710 to arcuate sections 1712 and 1714 such that sides 1706 and 1708 are not parallel to each other.

Preferably, this embodiment of blade 1700 has the following dimensions. Width A1 is preferably approximately 3 inches, and width A2 is preferably approximately 0.5 inches. Length R1 is preferably approximately 5.5 inches, the length R2 is approximately 4.8 inches, and the length R3 is approximately 4 inches. The thickness of the blade is approximately 0.06 inches. The radius of arcuate sections 1712 and 1714 is preferably approximately 2 inches, and the length of arcuate sections 1712 and 1714 is preferably approximately 0.7 inches. The dimensions of first end 1702 are preferably the same as described above for blade 10 such that the first end 1702 is configured to be secured to a reciprocating saw. Further, sides 1706 and 1708 are preferably positioned at approximately a 30 degree angle with respect to each other.

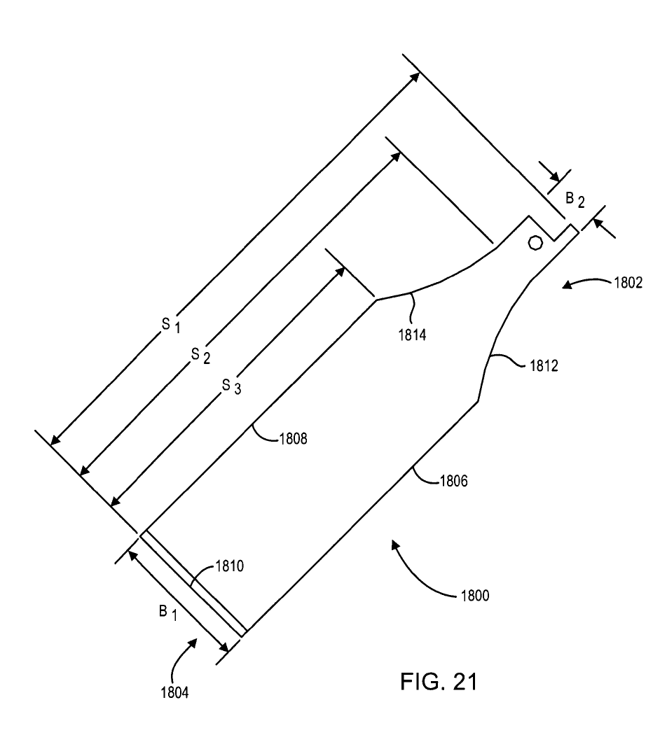

FIG. 21 shows another alternative embodiment of blade 1800 having a unitary body with first and second ends 1802 and 1804 respectively. First end 1802 has the same configuration as the first end of blade 10, shown in FIG. 1, for securing blade 1800 to a reciprocating saw. Blade 1800 has sides 1806 and 1808 and a cutting edge 1810, which in combination are generally in the shape of a rectangle. The blade has concave arcuate sections 1812 and 1814 which each have one end joined respectively with sides 1806 and 1808 and another end joined with first end 1802. The blade has an overall length S1, a length S2 representing the length of side 1808 and arcuate section 1814, and a length S3 representing the length of side 1808. The width of the blade's cutting edge 1810 is B1 and the width of first end 1802 is B2.

Preferably, this embodiment of blade 1800 has the following dimensions. The width B1 is preferably approximately 1.5 inches, and the width of B2 is preferably approximately 0.5 inches. The length S1 of the blade is preferably approximately 5.5 inches, the length S2 is preferably approximately 4.8 inches, and the length S3 is preferably approximately 3.6 inches. The thickness of the blade is preferably approximately 0.06 inches. The radius of arcuate sections 1812 and 1814 is preferably approximately 2 inches, and the length of arcuate sections 1812 and 1814 is preferably approximately 1.1 inches. The dimensions of first end 1802 are preferably the same as described above for blade 10 such that the first end 1802 is configured to be secured to a reciprocating saw.

In operation, first end 20 of blade 10, shown in FIG. 1, is inserted into the chuck of any reciprocating saw, such as reciprocating saw 36 shown in FIG. 3. The blade is secured within the chuck according to the procedure used for that particular reciprocating saw. In one embodiment, hole 26 receives a pin (not shown) in the reciprocating saw chuck for aligning the blade, and a plate and screw (not shown) clamp first end 20 to a surface within the reciprocating saw for securing the blade in the chuck. As described above, because the blade may be used with any type of reciprocating saw, other methods for mounting the blade to a reciprocating saw chuck are within the scope of the invention.

Once the blade is securely mounted to the reciprocating saw, then the reciprocating saw is positioned such that the planar top and bottom surfaces 12 and 14 of the blade are at a slight angle to the surface and material being scraped. The particular angle formed by the top and bottom surfaces 12 and 14, and the surface and material being scraped may be adjusted depending on the particular material being scraped. The reciprocating saw is then turned on. Preferably, the reciprocating saw is run at between approximately ½ speed to full speed, although it may be run at any speed depending on the type of material being scraped.

As the reciprocating saw moves the scraper blade back and forth, the cutting edge 30 separates the material being scraped from the surface that it is adhered to. The single beveled chisel cutting edge 30 assists the blade in sliding between the material being scraped and the surface that it is adhered to. The user of the saw does not need to impart significant force to the saw in order to scrape the material. The user only needs to securely grasp the saw to absorb any “kickback” force that may result from use of the saw.

If the blade is used to remove a flooring material such as vinyl flooring, rubber backed carpet, or linoleum, then preferably the flooring is first cut into manageable strips of approximately between 8 to 12 inches in width. The ends of each strip are pulled up so that the user can get the cutting edge 30 of the blade between the flooring material and the subfloor, or other surface, beneath the material. The saw is held at a slight angle to the flooring material, and then run at approximately ¾ speed. As the blade separates the flooring material from the subfloor, the user moves the saw down the strip of material until the entire strip is separated from the subfloor.

If the blade is used to remove wallpaper, then first the wallpaper is preferably coated with a mixture of 50% fabric softener and 50% water. The saw is held at a slight angle to the wallpaper and run at approximately ½ speed. The saw is moved across the wall until all of the wallpaper is separated from the wall. The saw is run at a slower speed for wallpaper, then it is for the flooring materials described above, so as not to damage the drywall surface that wallpaper is typically installed on. For removing wallpaper and protecting the drywall beneath, it may also be preferable to use a blade having a longer cutting edge in order to reduce the ratio of force per cutting edge length. A plastic blade made from one of the polymeric materials described above may also be used to remove wallpaper to prevent damage to the underlying drywall surface.

The blade may also be used to remove paint from a surface. To remove paint, the saw is preferably held at a slight angle to the painted surface and run at approximately ¾ speed. The speed of the saw may be increased or reduced depending on the particular surface that the paint is adhered to. For instance, if the surface is more susceptible to puncture, then a slower speed is preferably used.

Although specific processes are described above for removing flooring, wallpaper, and paint, the blade 10 may be used to scrape any material from any surface such as glue, chewing gum, mortar, thinset mortar, concrete, adhesive such as ceramic tile adhesive, epoxy, caulk, and drywall joint compound.

The alternative embodiments of blades described above and shown in FIGS. 4-10 and 12-21 are all used in substantially the same manner as described above for blade 10 shown in FIGS. 1 and 2. To use each of these blades, the blade is mounted to a reciprocating saw, the saw is held at a slight angle with respect to the surface being scraped, and the saw is turned on to scrape the surface. Otherwise, the functional differences between each of the alternative blade embodiments of FIGS. 4-10 and 12-21 and blade 10 are described above. The blade of FIG. 11 operates in a different manner than the rest of the blades, because it has a handle 800 that attaches to blade 10 for manually scraping material with the blade.

According to another alternative embodiment of blade, which is not shown, the blade is secured to an adapter that is then secured to a reciprocating saw chuck in the manner described above. The adapter preferably has a first end that is secured to the blade, and a second end that is secured to the reciprocating saw chuck. Any of the embodiments of blades described above may be used with an adapter in this manner. However, the first end of the blade may have a different mounting structure in order to accommodate the mounting structure of the adapter. From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A scraper blade comprising:
a first end configured to be mounted in a reciprocating saw chuck; and
a second end integrally joined with said first end and spaced apart from said first end, wherein said second end comprises a cutting edge.

2. The scraper blade of claim 1, further comprising a generally planar sheet comprising said first and second ends, and top and bottom surfaces.

3. The scraper blade of claim 1, wherein said first and second ends comprise heat treated steel comprising between approximately 0.45 to 1.05% carbon and between approximately 0.3 to 1.0% manganese.

4. The scraper blade of claim 3, wherein said heat treated steel comprises between approximately 0.7 to 0.8% carbon, between approximately 0.5 to 0.8% manganese, no more than approximately 0.04% phosphorus, and no more than approximately 0.05% sulfur.

5. The scraper blade of claim 3, wherein said steel is heat treated by a heat treatment selected from the group consisting of austempering and martempering.

6. The scraper blade of claim 3, wherein said cutting edge comprises a material that has a hardness on the Rockwell C scale that is greater than the hardness of said heat treated steel.

7. The scraper blade of claim 6, wherein said cutting edge comprises a material selected from the group consisting of cemented carbide, titanium carbide, tungsten carbide, boron carbide, silicon carbide, vanadium carbide, titanium carbide nitride, titanium nitride, titanium aluminum nitride, cubic boron nitride, polycrystalline diamond, and diamond.

8. The scraper blade of claim 1, wherein said first and second ends comprise a material having a yield tensile strength of between approximately 150,000 to 250,000 pounds per square inch, a modulus of elasticity of between approximately 20,000 to 40,000 kilopounds per square inch, and a hardness on the Rockwell C scale of between approximately 30 to 60.

9. The scraper blade of claim 8, wherein said first and second ends comprise a material having a yield tensile strength of between approximately 185,000 to 210,000 pounds per square inch, a modulus of elasticity of between approximately 27,500 to 32,500 kilopounds per square inch, and a hardness on the Rockwell C scale of between approximately 42 to 48.

10. The scraper blade of claim 1, wherein said cutting edge has a width between approximately 1 to 9 inches.

11. The scraper blade of claim 10, wherein said cutting edge has a width between approximately 1 to 3 inches.

12. The scraper blade of claim 10, wherein said cutting edge has a width between approximately 3 to 5 inches.

13. The scraper blade of claim 10, wherein said cutting edge has a width between approximately 5 to 7 inches.

14. The scraper blade of claim 10, wherein said cutting edge has a width between approximately 7 to 9 inches.

15. The scraper blade of claim 1, wherein said first and second ends have a thickness of between approximately 0.03 to 0.13 inches.

16. The scraper blade of claim 15, wherein said first and second ends have a thickness of approximately 0.06 inches.

17. The scraper blade of claim 1, wherein said first end has a width of between approximately 0.25 to 0.75 inches.

18. The scraper blade of claim 17, wherein said first end has a width of approximately 0.5 inches.

19. The scraper blade of claim 1, wherein the length from said first end to said second end is between approximately 3.5 to 7.5 inches.

20. The scraper blade of claim 19, wherein the length from said first end to said second end is approximately 5.5 inches.

21. The scraper blade of claim 1, wherein the length from said second end to the location where said first end is configured to be secured in a reciprocating saw chuck is between approximately 2.75 to 6.75 inches.

22. The scraper blade of claim 21, wherein the length from said second end to the location where said first end is configured to be secured in a reciprocating saw chuck is approximately 4.75 inches.

23. The scraper blade of claim 1, wherein the length from said second end to the location where said first end is configured to be secured in a reciprocating saw chuck is a distance L2, wherein the width of the first end is a distance W3, and wherein the ratio of L2 to W3 is between approximately 4 to 27.

24. The scraper blade of claim 23, wherein the ratio of L2 to W3 is approximately 10.

25. The scraper blade of claim 1, wherein the length from said second end to the location where said first end is configured to be secured in a reciprocating saw chuck is a distance L2, and wherein the ratio of L2 to the thickness of the first end is between approximately 21 to 225.

26. The scraper blade of claim 25, wherein the ratio of L2 to the thickness of the first end is approximately 75.

27. The scraper blade of claim 1, wherein the width of the first end is a distance W3, and wherein the ratio of W3 to the thickness of the first end is between approximately 2 to 25.

28. The scraper blade of claim 27, wherein the ratio of W3 to the thickness of the first end is approximately 8.

29. The scraper blade of claim 1, wherein the scraper blade is made from a material with a yield tensile strength of ay, the first end has a width of W3, the first end has a thickness of t, and the length from said second end to the location where said first end is configured to be secured in a reciprocating saw chuck is a distance L2, and wherein the value of (σ_{Y}*W3*t̂2)/L2 is between approximately 30 to 300 pounds.

30. The scraper blade of claim 29, wherein the value of (σ_{Y}*W3*t̂2)/L2 is between approximately 60 to 120 pounds.

31. The scraper blade of claim 1, further comprising a generally planar sheet comprising said first and second ends, and top and bottom surfaces, and wherein said blade does not plastically deform when a force of between approximately 5 to 50 pounds is applied to the second end of the blade in a direction that is generally perpendicular to the bottom surface.

32. The scraper blade of claim 31, wherein said blade does not plastically deform when a force of between approximately 10 to 20 pounds is applied to the second end of the blade in a direction that is generally perpendicular to the bottom surface.

33. The scraper blade of claim 1, wherein said cutting edge comprises a chisel.

34. The scraper blade of claim 33, wherein said chisel comprises a single beveled edge.

35. The scraper blade of claim 33, wherein said chisel comprises a double beveled edge.

36. The scraper blade of claim 1 further comprising a tapered waist integrally joined with said first and second ends and positioned between said first and second ends.

37. The scraper blade of claim 36, wherein said waist is flexible.

38. The scraper blade of claim 1, wherein said cutting edge is serrated.

39. The scraper blade of claim 1, wherein said cutting edge comprises saw teeth.

40. The scraper blade of claim 1, wherein said second end further comprises a plurality of openings.

41. The scraper blade of claim 1, wherein said second end further comprises a plurality of swages.

42. The scraper blade of claim 1 further comprising a handle mounted to said first end for manual use.

43. The scraper blade of claim 1, wherein said cutting edge is convex.

44. The scraper blade of claim 1, wherein said cutting edge is wedge-shaped.

45. The scraper blade of claim 1, wherein said cutting edge comprises a slot configured to receive a replaceable blade.

46. The scraper blade of claim 1, wherein said second end further comprises a plurality of serially aligned and removable cutting edges, and wherein a groove is formed between adjacent cutting edges for exposing the next cutting edge.

47. The scraper blade of claim 1, further comprising generally parallel opposed sides coupled with and positioned between said first and second ends, and wherein said cutting edge forms a non-perpendicular angle X with respect to each of said sides.

48. The scraper blade of claim 1, wherein said second end further comprises a side coupled with said cutting edge and extending toward said first end, and wherein said side is serrated.

49. The scraper blade of claim 1, wherein said second end further comprises opposed sides coupled with said cutting edge and extending toward said first end, and wherein a chamfer is formed between each of said sides and said cutting edge.

50. The scraper blade of claim 1, wherein said blade further comprises a first section comprising said first end and a second section comprising said second end, wherein there is an angle of between approximately 65 degrees to 115 degrees between said first and second sections.

51. A scraper blade comprising:
a first end comprising a mounting structure; and
a second end coupled with and spaced apart from said first end, wherein said second end comprises a cutting edge,
wherein said first and second ends comprise heat treated steel comprising between approximately 0.45 to 1.05% carbon and between approximately 0.3 to 1.0% manganese.

52. The scraper blade of claim 51, wherein said heat treated steel comprises between approximately 0.7 to 0.8% carbon, between approximately 0.5 to 0.8% manganese, no more than approximately 0.04% phosphorus, and no more than approximately 0.05% sulfur.

53. The scraper blade of claim 51, wherein said steel is heat treated by a heat treatment selected from the group consisting of austempering and martempering

54. The scraper blade of claim 51, wherein said first and second ends comprise a material having a yield tensile strength of between approximately 150,000 to 250,000 pounds per square inch, a modulus of elasticity of between approximately 20,000 to 40,000 kilopounds per square inch, and a hardness on the Rockwell C scale of between approximately 30 to 60.

55. The scraper blade of claim 54, wherein said first and second ends comprise a material having a yield tensile strength of between approximately 185,000 to 210,000 pounds per square inch, a modulus of elasticity of between approximately 27,500 to 32,500 kilopounds per square inch, and a hardness on the Rockwell C scale of between approximately 42 to 48.

56. The scraper blade of claim 51, wherein the first end is configured to be mounted in a reciprocating saw chuck.

57. A scraper blade comprising:
a first end comprising a mounting structure; and
a second end coupled with and spaced apart from said first end, wherein said second end comprises a cutting edge,
wherein said first and second ends comprise a material having a yield tensile strength of between approximately 150,000 to 250,000 pounds per square inch, a modulus of elasticity of between approximately 20,000 to 40,000 kilopounds per square inch, and a hardness on the Rockwell C scale of between approximately 30 to 60.

58. The scraper blade of claim 57, wherein said first and second ends comprise a material having a yield tensile strength of between approximately 185,000 to 210,000 pounds per square inch, a modulus of elasticity of between approximately 27,500 to 32,500 kilopounds per square inch, and a hardness on the Rockwell C scale of between approximately 42 to 48.

59. The scraper blade of claim 57, wherein the first end is configured to be mounted in a reciprocating saw chuck.
